(19) United States
(12) Patent Application Publication
(10) Pub. No.: US 2025/0370414 A1
(43) Pub. Date: Dec. 4, 2025

(54) AUTONOMOUS CONTROL SYSTEM AND SAFETY MONITORING SYSTEM

(71) Applicant: HITACHI, LTD., Tokyo (JP)

(72) Inventors: Satoshi OTSUKA, Tokyo (JP); Natsumi WATANABE, Tokyo (JP)

(21) Appl. No.: 18/870,848

(22) PCT Filed: Jun. 15, 2023
(86) PCT No.: PCT/JP2023/022282

§ 371 Date: Dec. 2, 2024

(30) Foreign Application Priority Data
Aug. 3, 2022 (JP) 2022-124006

(51) Int. Cl. G05B 9/02; B25J 9/16; B60W 60/00; G08G 1/16

(52) U.S. Cl. CPC G05B 9/02; B25J 9/1674; B60W 60/0015; G08G 1/16

(57) ABSTRACT

The present invention addresses the problem of providing an autonomous control system and a safety monitoring system that, even if a variety of circumstances of the autonomous control system have changed, enable proper reconfiguration of safety rules according to the changed circumstances or design conditions. The problem can be solved by including: a first safety layer for monitoring and controlling the safety of an apparatus on the basis of safety rules in the field; and a second safety layer for detecting system precondition deviations within design assumptions and reconfiguring the safety rules.

### TECHNICAL FIELD

The present invention relates to an autonomous control system and a safety monitoring system.

### BACKGROUND ART

As a background of this technical field, there has been known a Japanese Unexamined Patent Application Publication (Translation of PCT application) No. 2022-516559 (Patent Literature 1). In this publication, there is the description that “The present invention relates to a novel approach for managing an operation of an autonomous driving vehicle. More specifically, the present invention relates to a method and a system for improving permissiveness of an autonomous driving vehicle, a truck, an airplane, or other similar vehicles by mounting a computer-based system that alleviates restrictions relating to safety in cases considered appropriate without sacrificing the safety of the entire operation.” As another prior art, there has been known International Publication WO 2022/009900 (Patent Literature 2). In this publication, there is the description that “It is an object of the present invention to provide an autonomous driving device and a vehicle control method that can reduce a possibility of the occurrence of a case that a user is embarrassed. An automatic driving device for achieving such an object is, as an example, an autonomous driving device that prepares a control plan that allows a vehicle to autonomously travel using map data. The autonomous driving device includes: a map managing unit that determines an acquisition state of the data map; and a control planning unit that prepares a control plan using the map data, in which the control planning unit is configured to change a content of the control plan corresponding to the acquisition state of the map data that the map managing unit has determined.”

### CITATION LIST

### Patent Literature

Patent Literature 1: Japanese Unexamined Patent Application Publication (Translation of PCT Application) No. 2022-516559

Patent Literature 2: International Publication WO 2022/009900

### SUMMARY OF INVENTION

### Technical Problem

An autonomous control system according to the present invention is a system where a mobile object control system that controls an operation (for example, moving, transfer or the like) of a mobile object such as an automobile, a railway vehicle, a construction machine, an automated guided vehicle, a robot or the like, and a safety monitoring system that monitors a field where the mobile object is operated are connected with each other in a communicable manner. There is a case where equipment such as a mobile object controlled by an autonomous control system exists in mixture with a person (for example, a worker, a pedestrian or the like) in an environment where the equipment is used. In a case where safety of a person is ensured in such an environment, for example, by performing a control under a condition that, for example, a person and equipment (a mobile object) respectively follow safety rules (for example, the person or the equipment temporarily stops before entering an intersection, the person and the equipment follows traffic signals, the person does not approach an area within a fixed distance from the equipment and the like), and the autonomous control system also grasps the safety rules, the safety of the operations of the person and the equipment can be ensured.

With respect to the safety rules, to cope with the addition of the equipment, a change of a use objective, safety rules that have a margin is set (for example, ensuring a wide space secured around the equipment and the like). In this case, as a result, originally unnecessary restrictions are imposed on the respective equipment and the person and hence, there is a possibility that efficiency of the autonomous control system is lowered. On the other hand, in a case where limitative safety rules are set with respect to the current equipment and use objectives (for example, a space around the equipment is at least secured by estimating an operation speed of the equipment), the autonomous control system cannot cope with the addition of the equipment and a change in the use objectives of the equipment and hence, the safety rules are reviewed and the system is redesigned because of such a review. As a result, a change in the autonomous control system requires large man-hours.

The present invention has been made in view of the above-mentioned drawbacks, and it is an object of the present invention to provide an autonomous control system and a safety monitoring system where the safety rule can be properly reconfigured in accordance with a situation and a design condition where a safety rule is changed even when various situations of the autonomous control system are changed.

### Solution to Problem

To overcome the above-mentioned drawback, one aspect of the present invention may be performed using the technical concept described in claims, for example. That is, one aspect of the present invention includes: a first safety layer that monitors and controls safety of equipment based on a safety rule in a field; and a second safety layer that detects the deviation from a system prerequisite condition within design estimation, and reconfigures the safety rule.

### Advantageous Effects of Invention

According to the present invention, the reconfiguration of safety that corresponds to a change in environment (such as progress, change in application) of the autonomous control system can be properly performed within a short time. Further, even in a case where various situations relating to the autonomous control system change, safety rule can be reconfigured properly in conformity with a situation and design condition where the safety rule is changed.

Objects, the configurations and advantageous effects other than the above will become apparent by the description of embodiment made hereinafter.

### BRIEF DESCRIPTION OF DRAWINGS

FIG. 1 illustrates a configurational example of an autonomous control system that includes a safety monitoring system and a vehicle system according to a first embodiment.

FIG. 2 is a view illustrating an overall constitutional example of the autonomous control system according to the first embodiment.

FIG. 3 is a flowchart illustrating a processing flow in a safety monitoring system according to the first embodiment.

FIG. 4 is an explanatory view of a parameter examples of a system prerequisite condition.

FIG. 5 is a block diagram illustrating the relationship between a system prerequisite condition pattern and a safety design change pattern.

FIG. 6 is a block diagram illustrating a configurational example of safety rules.

FIG. 7 is a block diagram illustrating a configurational example of a main functional layer and a first safety layer.

FIG. 8 is a block diagram illustrating a configurational example of a second safety layer.

FIG. 9 is a block diagram illustrating a configurational example of a third safety layer.

FIG. 10 is a flowchart illustrating a processing flow at the time of updating safety rules according to a second embodiment.

FIG. 11 is a block diagram illustrating a configurational example of a second safety layer according to a third embodiment.

### DESCRIPTION OF EMBODIMENTS

Hereinafter, an example (an embodiment) of a preferred mode for carrying out the present invention is described using drawings. In this embodiment, the description is made with respect to an autonomous control system that is mainly constituted of: a safety monitoring system that monitors and controls a vehicle control system; and a vehicle system that includes the vehicle control system. The autonomous control system is preferably performed in the safety monitoring system that monitors and controls the vehicle control system. However, the application of the present invention to an autonomous control system that includes a system other than the vehicle control system is not obstructed.

For example, by taking a warehouse internal transfer system as an example, the vehicle system is replaced with a forklift or article transfer equipment, and an object is replaced with a worker working in the warehouse. In a case of an industrial system, a vehicle system is replaced with a work robot, and the object is replaced with a line worker. Even in such cases, substantially same advantageous effects can be estimated. Further, the vehicle system may be also replaced with aviation equipment such as a drone. In other words, as a controlled object of the present system, a robot in a factory, an existing system such as a railway, a three-dimensional mobile object such as air mobility and the like can be also estimated.

### First Embodiment

### Summary of System

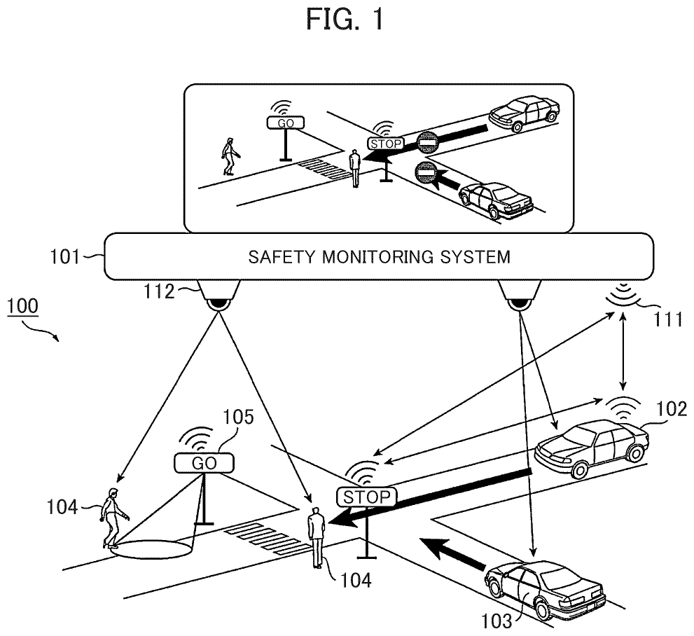

FIG. 1 illustrates an overall configuration of a field on which an autonomous control system according to a first embodiment is mounted. An autonomous control system 100 includes a safety monitoring system 101, a vehicle system 102, and an information transmission device 105. In the field, peripheral equipment, men and the like who are not control object of the autonomous control system 100 further exist (a non-communication vehicle system 103, objects 104).

The safety monitoring system 101 performs communication with a plurality of control systems such as vehicle control systems, and monitors the field that includes the vehicle system 102 and other objects (described later). The vehicle system 102 includes a communication device and the like, and also includes a vehicle control system that perform its operation while communicating with the above-mentioned safety monitoring system 101. The non-communication vehicle system 103 is a vehicle system that does not include a communication device and the like, and does not perform communication with the above-mentioned safety monitoring system 101. The object 104 is a pedestrian, a light vehicle (a bicycle and the like) and the like. The information transmission device 105 is a traffic signal that controls a traffic or the like, a communication device such as a smartphone or the like, and the like. The information transmission device 105 confirms the transmission of information to the object 104 such as a pedestrian and the response from the object 104.

The safety monitoring system 101 includes a communication device 111 and a monitoring device 112. The communication device 111 performs communication with the vehicle control system, information transmission device 105 and the like. The monitoring device 112 is, for example, a camera, a radar or a sensor such as Lidar that monitors the field.

### Overall System Architecture (Logic)

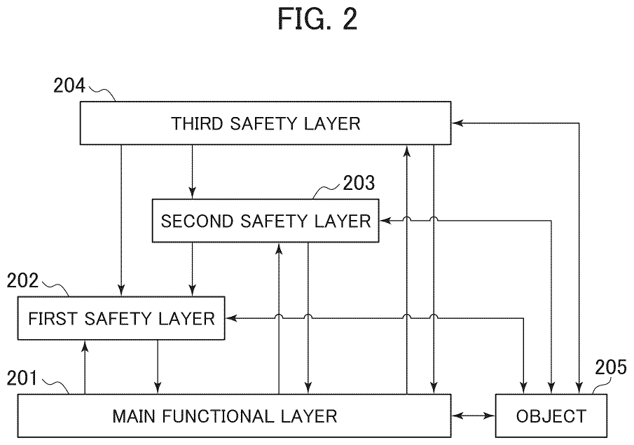

FIG. 2 illustrates the overall architecture of the autonomous control system according to the first embodiment. The autonomous control system 100 is, as the logic structure, constituted of a main functional layer 201, a first safety layer 202, a second safety layer 203, a third safety layer 204, and an object 205.

The main functional layer 201 is, for example, a part of the vehicle control system, and operates the vehicle system 102 in association with other safety layers 202, 203 and 204. The first safety layer 202 performs a control, in accordance with safety rules in the field, for maintaining a safety state or the transfer to the safety state by detecting abnormality in the main functional layer 201 and the field.

The second safety layer 203 detects the deviation from the system prerequisite condition described later and the above-mentioned deviation is within a design estimated range (in other words, the system prerequisite deviation within the estimation in design), and performs the reconfiguration of corresponding safety rules and an override of a control performed by the vehicle system 102. The third safety layer 204 detects the deviation from the system prerequisite condition and a state that the above-mentioned deviation is outside a design estimated range (in other words, the system prerequisite deviation outside the estimation in design), and performs the redesign of corresponding safety rules and an override of a control performed by the vehicle system 102.

The object 205 performs the transaction with the respective safety layers 202, 203, 204 or the main functional layer 201, receives the transmission of information relating to safety rules, and returns a response to the transmission. Further, the object 205 collects information on operations, positions and the like from the safety layers 202, 203 and 204 and the main functional layer 201.

### Example of Functional Arrangement

The system architecture illustrated in FIG. 2 is a logical structure, and the arrangement of the physical configurations of the respective functions is not limited to a one-to-one arrangement. In one example of the functional arrangement, the main functional layer 201 is arranged in the vehicle system 102, and the first to third safety layers 202, 203 and 204 are arranged in the safety monitoring system 101. Further, the transmission of information from the respective layers 201, 202, 203 and 204 to the object 205 is performed via the information transmission device 105, for example.

In another arrangement example, a part (diagnosis of a trouble of a vehicle and safety function of the vehicle) of the first safety layer 202 is arranged in the vehicle system 102. With such a configuration, the processing for a trouble is performed without via the communication and hence, a reaction speed is enhanced. Further, it is possible to integrate a function relating to the trouble of the vehicle with the vehicle and hence, the reuse of the vehicle system 102 and the safety monitoring system 101 can be facilitated.

In still another arrangement example, a detection function of the deviation from the system prerequisite condition in a safety layer described later (a part of a function of the safety layer) may be arranged in equipment such as the vehicle system 102. With such a configuration, it is unnecessary to transmit data (sensing data or the like) for determining the deviation from the system prerequisite condition from the vehicle system 102 or the like to the safety monitoring system 101, and instead, it is possible to transmit only the information that the deviation from the system prerequisite condition is generated. Accordingly, it is possible to expect the reduction of a processing load in the safety layer and the reduction of a load on network.

### Processing in Safety Monitoring System

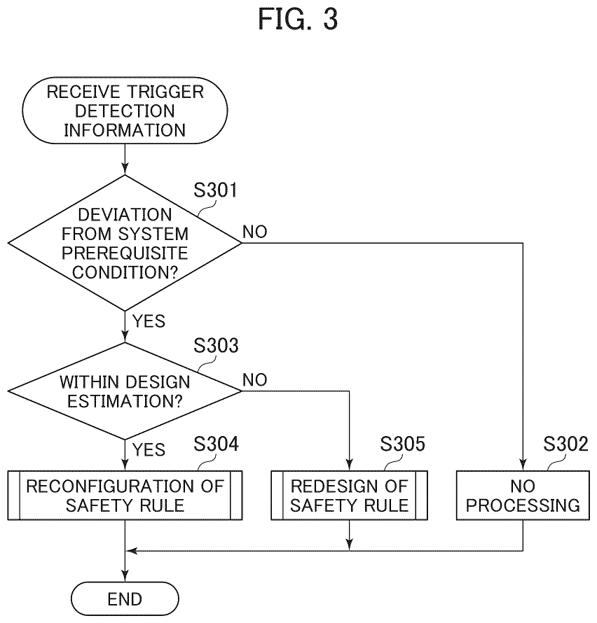

Next, the summary of the processing of the safety monitoring system 101 according to the first embodiment is illustrated in FIG. 3. The safety monitoring system 101 monitors a state of a field (including a state of equipment and an object) via the monitoring device 112 or the communication device 111 that the safety monitoring system 101 includes, for example. In a case where the safety monitoring system 101 detects the deviation (trigger) of the system prerequisite condition or in a case where the safety monitoring system 101 receives information from the vehicle system 102 or the like that the trigger was detected, the safety monitoring system 101 performs this flow.

As a result of determining the content of the trigger, in a case where the safety monitoring system 101 determines that neither a control object of the autonomous control system 100 nor a surrounding environment deviates the system requisite condition (determination method described later) (no in S301), the safety monitoring system 101 performs no particular processing (S302). In a case where the safety monitoring system 101 determines that the content of the trigger deviates the system prerequisite condition (yes in S301), next, the safety monitoring system 101 determines whether or not the deviation from the system prerequisite condition is within a design estimation range (determination method described later) (S303). As result of the determination, in a case where the deviation from the system prerequisite condition is within a design estimation range (yes in S303), the reconfiguration of the safety rules described later is performed (S304). In a case where the deviation from the system prerequisite condition is not within the design estimation range (outside the design estimation range) (no in S303), the redesign of the safety rules described later is performed (S305). With such processing, the safety monitoring system 101 performs updating (reconfiguration or redesign) of the safety rule corresponding to a state of the autonomous control system 100.

### Example of System Prerequisite Condition and Deviation from System Prerequisite Condition

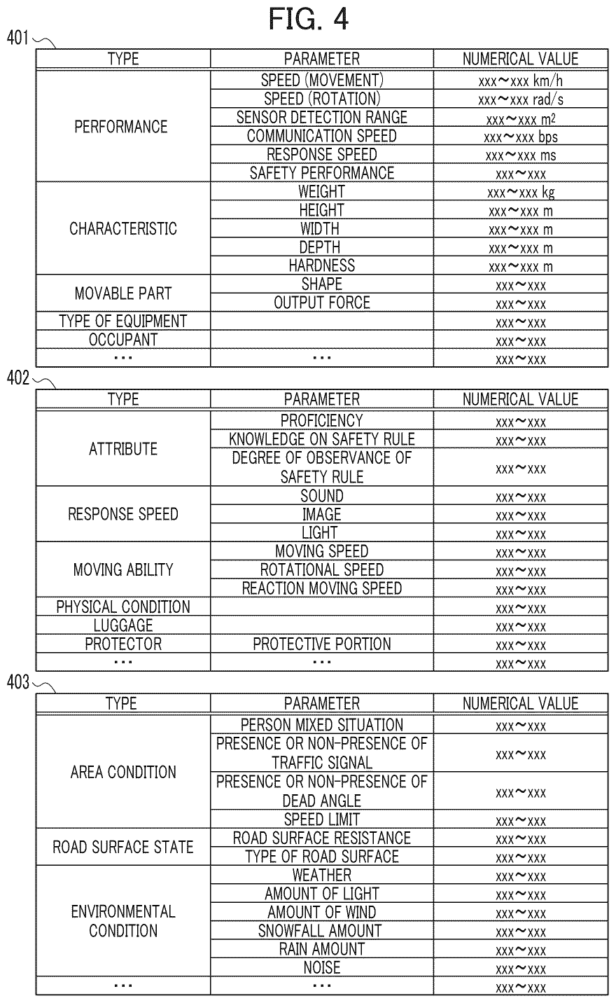

FIG. 4 illustrates examples of parameters in the system prerequisite condition. Symbol 401 indicates examples of parameters of (autonomous control) equipment, symbol 402 indicates examples of parameters of an object relating to the autonomous control system 100, and symbol 403 indicates examples of parameters of an environment (context) where the autonomous control system 100 is used.

As illustrated in the examples of parameters in 401, as the examples of the parameters of the equipment, performances of the equipment (moving and rotational speeds, detection range of the sensors (including area shape), communication speed (throughput latency), performances relating to safety (Fail-safe and Fail-operational, the presence or non-presence of safety mechanism and the like)), characteristics (weight, size (height, width, depth), hardness (changing risk as the time of collision) of equipment)), movable part (shape, output force of operation control), kind of the equipment (type of vehicle or the like), the number of occupants (including 0) and the like are named.

As examples of the object, for example, an operator associated with the autonomous control system 100, or a pedestrian or the like in a field. As indicated by 402, as the examples of the parameters of the object, attributes (proficiency (operation experience period or post), the possession or non-possession of knowledge on safety rules, compliance level of safety rules (whether the object being a person who observes rules or not), response speed to various indications and situations (sound, image, light), various mobility ability (speed (movement, rotation), reaction moving speed at the time of issuing an alarm), physical condition, transport good (weight and field of vision), the presence or non-presence of protector, place where the protector is disposed and the like are named.

As indicated by 403, as the examples of the parameters of the environment, the conditions of the area (the presence or non-presence of person, the presence or non-presence of traffic signal, the presence or non-presence of blind spot, speed limit), road surface states (road surface resistance, road surface type), environmental conditions (weather, amount of light, amount of wind, snowfall amount, rainfall amount, noise) and the like are named.

With respect to the respective tables, corresponding to the type of existing equipment and the type of an estimated object, and an environment (for example, estimating both of outdoor and indoor) that the autonomous control system 100 copes with, the combination of the plurality of these values is assumed as one system prerequisite condition. That is, the system prerequisite condition has information that influences the safety design relating to the equipment, a person and the environment respectively, and the information relating to the equipment, the person and the environment have ranges respectively.

These parameters are the parameters that are provided on the premise that the analysis of safety and the design of safety are performed. For example, parameters whose changes require the change in the results of the analysis of safety and the design of safety are estimated. For example, in a case where the design of safety is performed on a premise that the moving speed of the autonomous control system 100 is a low speed and equipment that moves at a high speed is newly added to the field, there is a possibility that the results of the analysis of safety and the design of safety change along with a change in an estimated risk and a change in the risk. The same goes for a change in a person or a change in the environment. In this case, it is necessary for the autonomous control system 100 to perform a safe control in conformity with a change in situation.

### Definition of Whether or Not Deviation Fall Within Design Estimated Range

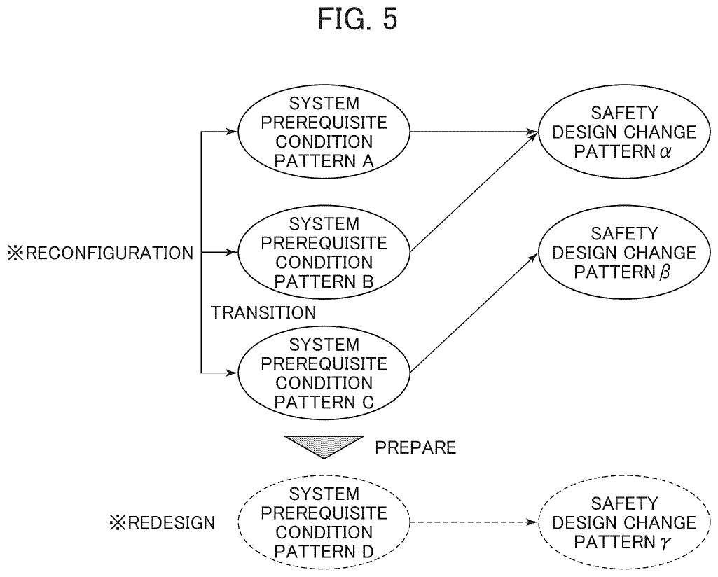

Next, the method of determining whether or not the deviation from system prerequisite condition is within design estimation ranges is described with reference to FIG. 5. First, in designing the autonomous control system 100 according to this embodiment, a plurality of patterns (A to C in this embodiment) are designed with respect to the system prerequisite condition. Further, safety design change patterns (a and B in this embodiment) corresponding to the patterns relating to the system prerequisite conditions are also designed. That is, as illustrated in FIG. 5, the combination of two or more system prerequisite condition patterns and the corresponding safety design change patterns is designed as a table. In the respective system prerequisite condition patterns, the parameters have ranges (domains or lists) (see FIG. 4), and it is rendered that the system prerequisite condition is unchanged provided that the parameters fall within the ranges. On the other hand, in a case where the deviation is outside the system prerequisite condition, it is checked whether the parameters fall within the parameter ranges of other system prerequisite condition patterns (for example, B or C in a case where the deviation is outside the system prerequisite condition pattern A in this example). In a case where the parameters of the changed system prerequisite condition is within the parameter ranges of the system prerequisite conditions of other patterns (for example, the parameters of the changed system prerequisite condition falls within the parameter ranges of C), it is determined that the deviation is within the design estimated range. That is, in a case where the current system prerequisite condition agrees with the system prerequisite condition pattern, it is determined that the deviation is within the range of the design estimated range. In a case where the parameters of the changed system prerequisite condition are not included in ranges of parameters of the system prerequisite conditions of other patterns, it is determined that the deviation is outside the design estimated range. That is, in a case where the current system prerequisite condition does not agree with the condition of the system prerequisite pattern, it is determined that the deviation is outside the design estimated range.

In a case where the deviation from the system prerequisite condition exists and the deviation is within the designed estimated range (for example, within a range of the system prerequisite condition pattern C), the reconfiguration of the safety rule described later is performed using the corresponding safety design change pattern (in this embodiment, the safety design change pattern β).

In a case where the deviation from the system prerequisite condition exists and the deviation is not within the design estimated range (for example, outside the design estimated range), the redesign of the safety rule described later is performed and, for example, the safety design change pattern γ in a case of the system prerequisite condition D illustrated in FIG. 5 is designed.

The safety design change pattern is constructed such that a designer or the like performs a safety analysis based on the system prerequisite condition pattern, performs a hazard analysis and a reassessment under the above-mentioned system prerequisite condition thus performing the safety design.

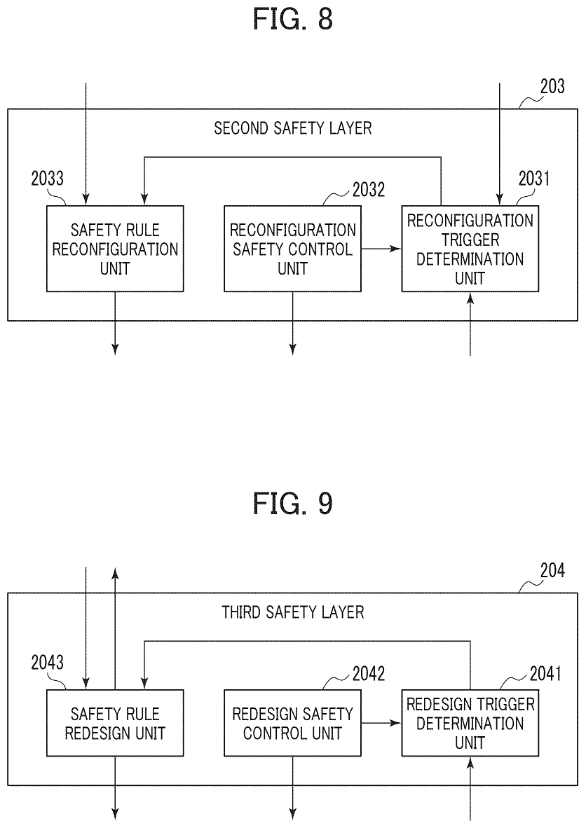

With respect to the system prerequisite condition pattern or in the safety design change pattern, for example, such patterns are held by a reconstitution trigger determining unit 2031 (FIG. 8) and by a redesign trigger determination unit 2041 (FIG. 9) for determination. Further, with respect to these information, each time, the second safety layer 203 or the third safety layer 204 performs an inquiry to an external database or the like. By adopting such processing, the reduction of the memory, and the easy updating to the newest information (an external database being updated) can be performed.

In this embodiment, it is designed such that at least one or more safety design change pattern corresponding to the system prerequisite condition pattern surely exists. In case where the safety design change pattern corresponding to the system prerequisite condition pattern does not exists, it determined that the deviation is not within the design estimated region.

Further, the same safety design change pattern may be used in a plurality of system prerequisite condition patterns. In the example illustrated in FIG. 5, the same safety design change pattern α is used (designed) in two system prerequisite condition patterns A and B. In this case, it is unnecessary to change the safety design pattern due to the transition between these system prerequisite condition patterns. Accordingly, the processing for the reconfiguration of the safety rules can be omitted and hence, it is possible to reduce a load for performing and processing an unnecessary safety control.

### Reconfiguration of Safety Rules

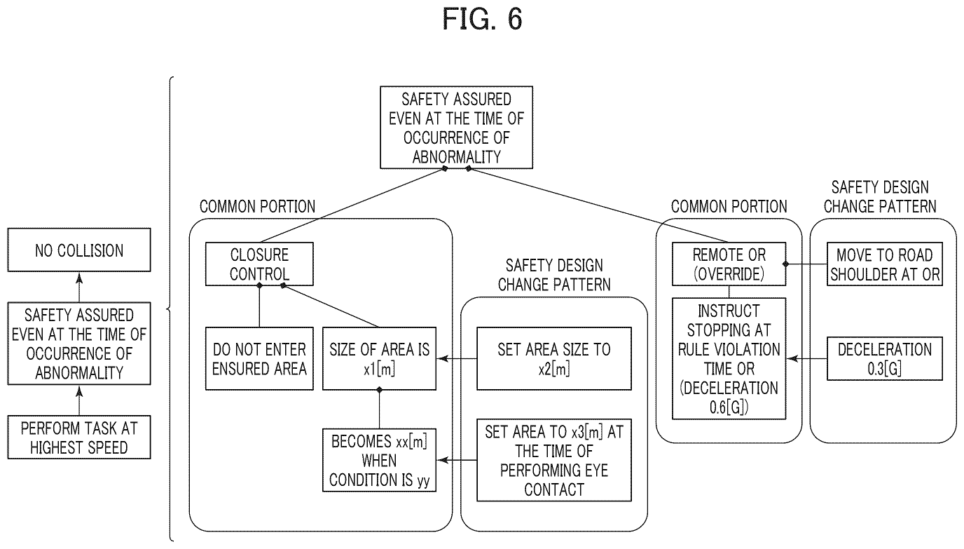

FIG. 6 illustrates the structure of the safety rules. The leftmost side in FIG. 6 illustrates a hierarchical example of the safety rules, and a control is performed such that the priority is assigned to the safety rule at the top. First, “not cause collision” is the safety rule at the top. To realize this safety rule, “keep safety even at the time of occurrence of abnormality” becomes necessary. On a condition that such safety rules are satisfied, it is possible to construct the safety rule where an operation is efficiently performed while maintaining the safety in accordance with the safety rule “perform a task at a highest speed”.

Among such configuration, the content of the safety rule “keep safety even at the time of occurrence of abnormality” is illustrated in an exploded manner in the form of a structure on a right side in FIG. 6. In this case, the safety rule “keep safety even at the time of occurrence of abnormality” is constituted of: a safety rule referred to as “closure control” that ensures safety by basically preventing a plurality of objects from entering the same area; and a safety rule referred to as “remote OR (override)” that ensures safety under a safety rule that, even in a case where on object or the like that violates the closure control exists, safety is ensured by a safety rule that the equipment is forcibly controlled (for example, decelerated or stopped) from a remote place.

The safety rule “closure control” is constituted of a safety rule “preventing an object from an ensured area”; a safety rule “the size of the area is x1[m]”; and a safety rule “the size of the area becomes xx[m] when a condition yy is satisfied”. Usually, the autonomous control system 100 performs a control using these parameters.

In the above-mentioned case, when the system prerequisite condition changes and, as a result, the size of the area where the closure control is performed is x2[m] in the corresponding safety design change pattern, the safety rule is updated and reconfigured. In succeeding steps, the entire autonomous control system 100 performs processing in accordance with the updated safety rule.

As another example, assume a case where the system prerequisite condition is changed so that a change of performing an eye contact (an operation that the object and the equipment have succeeded in communicating with each other relating to the safety) takes place as a new behavior of the object. In a case where the safety design change pattern that corresponds to such a case is “when performing an eye contact, an area in a close control is set to x3[m] (for example, x1>x3)”, the safety rule is reconfigured by updating the safety rule to such a content.

Also with respect to the content of “remote OR (override)”, in the same manner as the above, the safety rule is updated by determining whether or not the deviation is within the design estimated range, that is, by referencing the safety design change pattern that corresponds to a change in the system prerequisite condition (for example, the addition of high-speed equipment, the increase of speed limit to cope with the addition of a fragile item to a conveying item, the reduction of a safety margin as a person grows up, and the like).

The safety rule updated by the reconfiguration is notified to the main functional layer 201 and the first safety layer 202 in logically speaking, or to the entirety of the equipment or the object in the field in physically speaking, using communication or other methods (including the notification by the information transmission device 105).

The reconfiguration of the safety rule is performed as described above.

### Redesign of Safety Rule

In a case where the system prerequisite condition after the change is not included in the range of the above-mentioned system prerequisite condition, the redesign of the safety rule becomes necessary. With respect to the redesign of the safety rule, the redesign can be facilitated by notifying which parameters in the system prerequisite condition after the change do not fall within the range. That is, as a trigger for performing the redesign of the safety rule, the configuration that transmits the information on disagreement of the system prerequisite conditions is used. As the result of such redesign, the pattern of the system prerequisite condition and the safety design change pattern are newly added. By performing the reconfiguration processing of the safety rule using these parameters, it is possible to safely perform the control by the autonomous control system 100 based on the new safety rule.

The safety rule updated by the redesign is notified in the same manner as the content described in the reconfiguration.

Further, by performing the redesign of the safety rule, the system prerequisite condition pattern or the safety design change patter is updated.

### Main Functional Layer and First Safety Layer

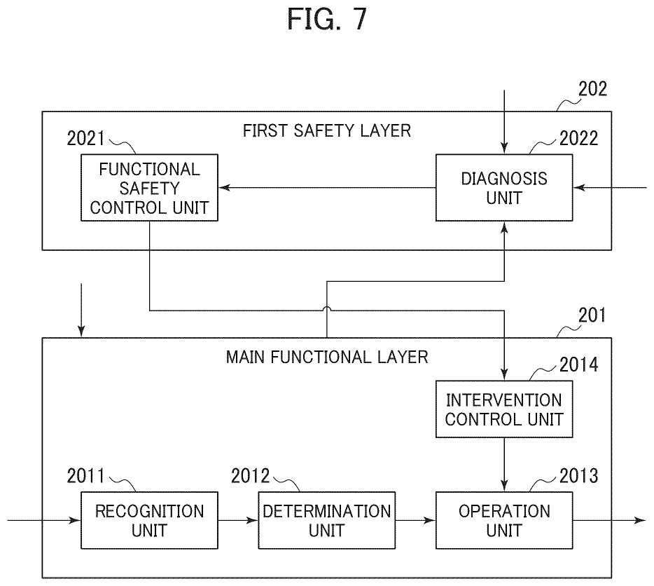

Next, the summary of the main functional layer 201 and the first safety layer 202 is described with reference to FIG. 7.

The main functional layer 201 includes: a recognition unit 2011 that prepares mainly a map that indicates the situation of a field such as a surrounding of equipment based on information received from sensors and communication equipment; a determination unit 2012 that prepares a behavior plan and a control plan of equipment based on information outputted from the recognition unit 2011: an operation unit 2013 that outputs a signal for controlling an actuator or the like based on the behavior plan and the control plan outputted from the determination unit 2012; and an intervention control unit 2014 that, in a case where equipment or an object around the equipment falls in a critical state, receives an override instruction from the outside and intervenes to the control that the operation unit 2013 performs. The respective units in the main functional layer 201 receives the notification of the safety rule relating to the main functional layer 201 and performs a corresponding control. For example, the control plan that the determination unit 2012 generates is generated in such a manner that the determination unit 2012 does not violate the safety rule.

In such processing, the intervention control unit 2014 performs the important function with respect to the safety and hence, a highly reliable device (safety microcomputer) is used among the arranged equipment.

In the override, a control such as a control of stopping a vehicle by decelerating the vehicle or a control of avoiding a collision by steering a vehicle depending on a situation, or a control of maintaining a small risk state such as temporary stopping of the system, holding the system in a still state or the like is performed. The same goes for the override performed at the time of safety control described hereinafter.

Next, the summary of the first safety layer 202 is described.

The first safety layer 202 is constituted of: a diagnosis unit 2022 that diagnoses abnormality of the main functional layer 201 or a non-safe phenomenon (the violation of a safety rule and the like) of a field by in combination with information and a safety rule obtained via the monitoring device 112 and the communication device 111 and the like; and a functional safety control unit 2021 that performs a corresponding control such as an override instruction with respect to the main functional layer 201 based on a diagnosis result of the diagnosis unit 2022.

The above-mentioned diagnosis unit 2022 performs, for grasping the safety rule, receives safety rule updated information with respect to the updated safety rule from the second safety layer 203 or the third safety layer 204, and performs a diagnosis based on the updated safety rule.

### Second Safety Layer

The summary of the second safety layer 203 is described with reference to FIG. 8.

The second safety layer 203 is constituted of: a reconfiguration trigger determination unit 2031 that performs determination from a system prerequisite condition pattern and a safety design change pattern that holds the deviation from the system prerequisite condition within and outside the design estimated range, the communication with the main functional layer 201 and a present system prerequisite condition detected using the monitoring device 112; a reconfiguration safety control unit 2032 that performs a safety control (an override or the like) at the time of reconfiguration using the result of the determination; and a safety rule reconfiguring unit 2033 that reconfigures the safety rule using the above-mentioned result of determination and the previously mentioned method, and performs notification with respect to the updated safety rule to equipment and an object in a field.

With respect to the safety control at the time of performing the reconfiguration, as described previously, even if the system prerequisite condition pattern changes, in a case where there exists no change in the safety design change pattern, it is unnecessary to perform safety control processing particularly. With such processing, unnecessary stopping of the system can be prevented.

### Third Safety Layer

The summary of the third safety layer 204 is described with reference to FIG. 9.

The third safety layer 204 is constituted of: a redesign trigger determination unit 2041 that performs determination from a system prerequisite condition pattern and a safety design change pattern that holds the deviation from the system prerequisite condition within and outside the design estimated range, the communication with the main functional layer 201 and a present system prerequisite condition detected using the monitoring device 112 in the manner described above; a redesign safety control unit 2042 that performs a safety control (an override or the like) at the time of redesign using the result of the determination; and a safety rule redesign unit 2043 that redesigns the safety rule using the above-mentioned result of determination and the previously mentioned method, and performs notification with respect to the updated safety rule to equipment and an object in a field.

With such a configuration, the reconfiguration of safety that corresponds to an environmental change (progress, change of application or the like) of the autonomous control system 100 can be realized within a short time and properly. That is, even in a case where various situations of the autonomous control system 100 change, the reconfiguration can be properly made in conformity with the situation where the safety rule has changed and the designing condition.

### Second Embodiment

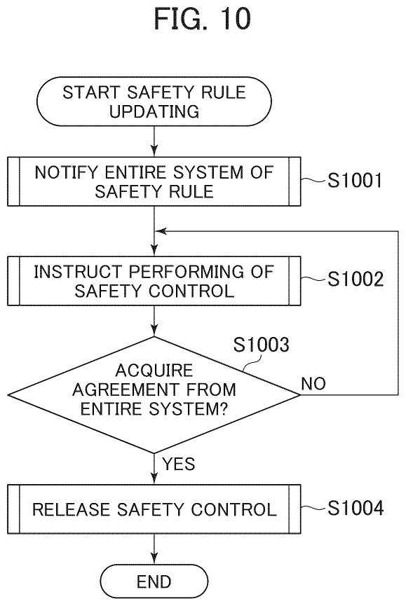

Next, the method of maintaining a safety control of the system until the developing of the safety rule is completed is described with reference to FIG. 10. This flow is performed by the second safety layer 203 or the third safety layer 204. In the description made hereinafter, the steps of performing the safety control by the second safety layer 203 is described.

First, the second safety layer 203 determines the trigger for the reconfiguration of the safety rule by the reconfiguration trigger determination unit 2031. In a case where the second safety layer 203 determines that the reconfiguration of the safety rule is necessary, the safety rule is notified to the entire autonomous control system 100 (S1001). Specifically, the reconfiguration trigger determination unit 2031 issues an instruction of performing the reconfiguration of the safety rule and the notification of the updating of the safety rule to the entire field to the safety rule reconfiguration unit 2033. Then, the reconfiguration trigger determination unit 2031 instructs the reconfiguration safety control unit 2032 to perform the safety control (an override or the like) (S1002).

Then, the reconfiguration trigger determination unit 2031 confirms the transmission and the reception of the safety rule from various equipment in the autonomous control system 100 (for example, the vehicle system 102, the non-communication vehicle system 103) and the object 104 to the reconfiguration trigger determination unit 2031. As the method of checking, the determination is performed based on a response in communication, a behavior of a person (a response sign). In other words, the reconfiguration trigger determination unit 2031 confirms whether or not a consensus is acquired from the entire autonomous control system 100. As a result, in a case the reconfiguration trigger determination unit 2031 does not receive responses from the equipment in the entire field or from all objects (no in S1003), the maintenance of safety control state is performed. In a case where the responses can be acquired from all equipment and all objects (yes in S1003), the safety control state is released (S1004) and, thereafter, the entire autonomous control system 100 performs a control in accordance with the updated safety rule. That is, the reconfiguration trigger determination unit 2031 confirms the responses from the respective equipment and objects in response to the notification of updating of the safety rule, and performs a control using a new safety rule.

Also in the processing performed in the third safety layer 204, by replacing the processing in the reconfiguration trigger determination unit 2031 described above with the processing in the redesign trigger determination unit 2041, by replacing the processing in the above-mentioned reconfiguration safety control unit 2032 with the processing in the redesign safety control unit 2042, and by replacing the processing in the above-mentioned safety rule reconfiguration unit 2033 with the processing in the safety rule redesign unit 2043, the processing at the time of performing the redesign of the safety rule can be performed substantially in the same manner.

By perform such processing, it is possible to prevent the performance of the processing due to disagreement of the safety rules (for example, a contact or the like due to an error in the determination of a margin) that may cause a dangerous phenomenon and hence, the processing can be performed safely after checking that the safety rules agree with each other in the entire field.

### Third Embodiment

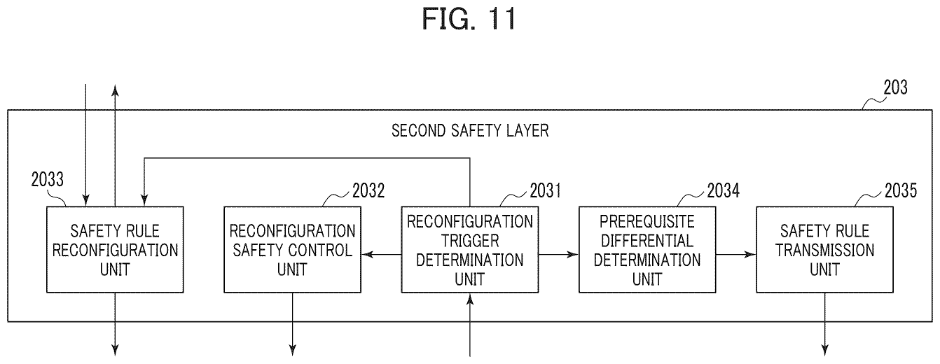

Next, a method of efficiently updating the safety rule in a case where novel equipment or person intends to participate a field is described. The configuration of the second safety layer 203 according to the third embodiment is illustrated in FIG. 11.

A second safety layer 203 according the present embodiment includes: a prerequisite differential determination unit 2034 that detects a differential of a system prerequisite condition relating to grasping of a safety rule of an object; and a safety rule transmission unit 2035 that transmits a safety rule for eliminating a differential (a differential of a grasping condition of the safety rule of the object) determined by the above-mentioned prerequisite differential determination unit 2034 (for example, a safety rule that a temporary stop is performed at an intersection in a case where the object does not know the rule of temporary stop at the intersection).

First, a case is exemplified where a person who does not know a safety rule (assuming such a person as an object A) newly enters a field that the autonomous control system 100 manages. In this case, the reconfiguration trigger determination unit 2031 in the second safety layer 203, as has been described in the first and second embodiments, confirms the deviation from the system prerequisite condition (a state that parameters of the object A (grasping of the safety rules) do not agree with the present system prerequisite condition) and performs the reconfiguration of the safety rule as described.

Next, the prerequisite differential determination unit 2034 that receives the information relating to the deviation from the above-mentioned system prerequisite condition (the system prerequisite condition before the change and the system prerequisite condition after the change) from the reconfiguration trigger determination unit 2031, based on a differential between the system prerequisite conditions before and after the change, grasps a safety rule where the object A is the differential, and determines that the system prerequisite condition satisfies the system prerequisite condition before the change. As a result, the prerequisite differential determination unit 2034 instructs the safety rule transmission unit 2035 to notify the object A of the differential safety rule, and the safety rule transmission unit 2035 notifies the object A of the differential safety rule.

As a result of notification, the object A grasps the safety rule, and the reconfiguration trigger determination unit 2031 confirms that the system prerequisite condition is again changed, and performs the reconfiguration of the safety rule again. That is, in the present embodiment, the reconfiguration trigger determination unit 2031 notifies the object A who does not grasp the safety rule of the information of the safety rule, and the object A receives the result and performs the reconfiguration of the safety rule.

In this manner, in a case where an object such as a new person enters a field, the rule is changed to the safety and, thereafter, the object is notified of the rule and is made to grasp the rule. Accordingly, the system can be operated on an efficient system prerequisite condition on a premise that all persons grasp the safety rule.

Although the case of the notification to the object has been described, also in the case of equipment, the equipment is notified of the safety rule and is made to grasp the safety rule and, thereafter, the system can perform its operation on a premise that the entire system grasps the safety rule.

Further, besides the grasping of the safety rule, for example, in a case where a transport amount of luggage exceeds a limit determined by a regulation or the like, the object or the equipment is notified of the matter, and the object or the equipment lowers the transport amount below the limit and hence, the entire system can perform its operation the safety rule efficiently.

Further, the redesign is performed instead of the reconfiguration, even in a case where the processing is performed in the third safety layer 204, by replacing the processing in the reconfiguration trigger determination unit 2031 described above with the processing in the redesign trigger determination unit 2041, by replacing the processing in the above-mentioned reconfiguration safety control unit 2032 with the processing in the redesign safety control unit 2042, by replacing the processing in the above-mentioned safety rule reconfiguration unit 2033 with the processing in the safety rule redesign unit 2043, and by arranging the prerequisite differential determination unit 2034 and the safety rule transmission unit 2035 on the third safety layer 204, the processing at the time of performing the redesign of the safety rule can be performed substantially in the same manner.

### Fourth Embodiment

Next, an example where the present invention is applied to industrial equipment is described. First, with respect to the applying of the present invention to an autonomous control system that includes a transfer robot in a factory, by replacing the above-mentioned vehicle system with the transfer robot and by estimating a worker as an object, it is possible to perform a control based on safety rule by performing the reconfiguration and the redesign of the safety rule as described in the first to third embodiments. On the other hand, the industrial equipment generates a large amount of equipment energy and, as a result, a risk value is high. Accordingly, the safety designing that takes the above into account becomes necessary.

In a case where the present invention is applied to equipment such as a robot arm, the main risk resides in a cooperative operation between an arm and a worker, a state where an arm and a worker are brought into contact with each other. Under such circumstances, as system prerequisite conditions, a movable range, a speed, a sensor range, communication and response speeds, safety performance (the presence or the non-presence of a fail-safe mechanism and the like) of a robot arm are named. As parameters of a worker who is an object, proficiency, the grasping or non-grasping of safety rule, and a height of a person (a contact position or a possibility of contacting) are named. Further, as the safety rule, the maintenance of distance for preventing the collision is named, and the parameter of the distance is set under the above-mentioned conditions. Further, the first safety layer 202 performs the above-mentioned maintenance of the distance by sensing or a defect diagnosis, and the second safety layer 203 and the third safety layer 204 perform the reconfiguration and the redesign of the safety rule as described above. Accordingly, also with respect to the industrial equipment, it is possible to perform a safety control that conforms to the safety rule corresponding to a change in the system prerequisite condition.

### Recapitulation of First to Fourth Embodiments

According to the embodiments described above, with the use of the first safety layer 202 that monitors and controls the safety of the equipment based on the safety rule in the field and the second safety layer 203 that detects the deviation from the system prerequisite condition within the design estimation and performs the reconfiguration of the safety rule, even when the deviation from the system prerequisite condition occurs, the reconfiguration of the safety rule corresponding to the deviation is performed within the design estimation and hence, the control can be safely continued.

Further, the autonomous control system further includes, in addition to the above-mentioned configuration, the third safety layer 204 that detects the deviation of the system prerequisite condition outside the design estimation and performs the redesign of the safety rule. Accordingly, it is possible to perform the redesign of the safety rule that corresponds to the system prerequisite condition outside the design estimation.

Further, at the time of performing the detection of the deviation from the system prerequisite condition and performing the reconfiguration or the redesign of the safety rule, by performing a control for maintaining the safety of the field, it is possible to maintain the safety at the time of updating the safety rule.

Further, the detecting function of the deviation from the system prerequisite condition that is a part of the function of the second safety layer 203 or the third safety layer 204 is mounted on the equipment. Accordingly, a transmission amount of information can be reduced.

Further, by transmitting information on the disagreement of the system prerequisite condition as a trigger of the redesign of the safety rule, the redesign of the safety rule is facilitated.

Further, in another embodiment, by confirming the response to the equipment and the object to the updating notification of the safety rule, and by performing a control using the novel safety rule, it is possible to prevent the occurrence of a risky phenomenon due to the disagreement between the safety rules.

Further, according to another embodiment, in addition to the above-mentioned configuration, the autonomous control system includes: the prerequisite differential determination unit 2034 that detects a differential of a system prerequisite condition relating to grasping of a safety rule of an object; and the safety rule transmission unit 2035 that performs the transmission with respect to a differential of grasping condition of the safety rule determined based on the differential. The notification of information of the safety rule is performed to the object that does not grasp the safety rule, and the object performs the reconfiguration or the redesign of the safety rule by receiving the result. Accordingly, the autonomous control system 100 is operated under the efficient system prerequisite condition on a premise that the entire autonomous control system 100 grasps the safety rule.

With such configuration, according to the present embodiment, the reconfiguration of the safety that corresponds to a change in environment (progress, a change in application or the like) of the autonomous control system can be realized properly within a short time. Accordingly, even in a case where various situations relating to the autonomous control system 100 change, the safety rule can be reconfigured properly in conformity with a situation and design condition where the safety rule is changed.

The present invention is not limited to the above-mentioned embodiment, and includes various modifications. For example, the above-mentioned embodiments have been described in detail to facilitate the understanding of the present invention, and the present invention is not always the case that the present invention is limited to all the configurations described in the embodiments. Further, a part of the configuration of a certain embodiment can be replaced with the configuration of another embodiment, or the configuration of another embodiment may be added to the configuration of another embodiment. In addition, part of the configuration of each of the embodiments can be subjected to addition, deletion, and replacement with respect to other configurations.

Further, a part or the entirety of each of the respective configurations, functions, processing units, processing mean and the like described above may be realized by a hardware such that the part or the entirety of each of the respective configurations is designed by an integrated circuit, for example. Further, the respective configurations, functions and the like described above may be realized by allowing a processor to construe programs that realize the respective functions and to execute the programs by software. Information such as programs to realize the functions, tapes, files and the like can be stored in a storage device such as a memory, a hard disk, a solid state drive (SSD), or a storage medium such as an IC card, an SD card, a DVD card or the like.

Further, with respect to control lines and information lines, only the lines that are considered necessary for the sake of the explanation of the present invention, and it is not always the case that all controls lines and all information lines necessary in terms of a product are illustrated. In an actual product, it is safe to say that almost all configurations are connected with each other.

### List of Reference Signs

100: autonomous control system
101: safety monitoring system
102: vehicle system
103: non-communication vehicle system
104: object
105: information transmission device
111: communication device
112: monitoring device
201: main functional layer
202: first safety layer
203: second safety layer
204: third safety layer
401: system prerequisite condition (equipment)
402: system prerequisite condition (object)
403: system prerequisite condition (environment)
2011: recognition unit
2012: determination unit
2013: operation unit
2014: intervention control unit
2021: functional safety control unit
2022: diagnosis unit
2031: reconfiguration trigger determination unit
2032: reconfiguration safety control unit
2033: safety rule reconfiguration unit
2041: redesign trigger determination unit
2042: redesign safety control unit
2043: safety rule redesign unit
2034: prerequisite differential determination unit
2035: safety rule transmission unit

1. An autonomous control system comprising:
a main functional layer that operates equipment;
a first safety layer that monitors safety of the device, and performs a corresponding control to the main functional layer based on a safety rule in a field; and
a second safety layer that detects a deviation from a system prerequisite condition within a design estimation, performs a reconfiguration of the safety rule, and notifies the safety rule that is updated by the reconfiguration.

2. The autonomous control system according to claim 1,
further comprising a third safety layer that detects the deviation from the system prerequisite condition outside the design estimation, and performs a redesign of the safety rule.

3. The autonomous control system according to claim 2,
wherein, in detecting the deviation from the system prerequisite condition and performing reconfiguration and redesign of the safety rule, a control for maintaining safety of the field is performed.

4. The autonomous control system according to claim 1,
wherein, the autonomous control system has a combination of two or more system prerequisite condition patterns and corresponding safety design change patterns as a table, and when a present system prerequisite condition agrees with a condition of the system prerequisite condition pattern, it is determined that the deviation is within design estimation.

5. The autonomous control system according to claim 4,
wherein, the system prerequisite condition has information that influences safety design relating to equipment, a person and an environment, and each of the information has a range.

6. The autonomous control system according to claim 2,
wherein, information on disagreement between the system prerequisite conditions is transmitted using a trigger of the redesign of the safety rule.

7. The autonomous control system according to claim 3,
wherein a response of equipment and a response of an object to notification of updating of the safety rule are checked, and a control under a novel safety rule is performed.

8. The autonomous control system according to claim 2,
wherein a detection function of the deviation from the system prerequisite condition that is a part of a function of the second safety layer or the third safety layer is mounted on the equipment.

9. The autonomous control system according to claim 2,
further comprising: a prerequisite differential determination unit that detects a differential of the system prerequisite condition relating to grasping of the safety rule; and a safety rule transmission unit that performs transmission with respect to the differential of the grasped condition of the safety rule determined based on the differential, wherein, notification of information of the safety rule is performed with respect to an object that does not grasp the safety rule, and the object receives the result and performs reconfiguration or redesign of the safety rule.

10. The autonomous control system according to claim 2,
wherein the autonomous control system has a combination of two or more system prerequisite condition patterns and corresponding safety design change patterns as a table, and when a present system prerequisite condition does not agree with a condition of the system prerequisite condition pattern, it is determined that the safety rule is outside design estimation.

11. A safety monitoring system comprising:
a first safety layer that monitors and controls safety of equipment based on a safety rule in a field;
a second safety layer that detects deviation from a system prerequisite condition within design estimation, and performs reconfiguration of the safety rule.

12. The safety monitoring system according to claim 11,
further comprising a third safety layer that detects deviation from the system prerequisite condition outside the design estimation, and performs redesign of the safety rule.

13. The safety monitoring system according to claim 12,
wherein in detecting the deviation from the system prerequisite condition and performing reconfiguration or redesign of the safety rule, a control for maintaining safety in the field is performed.
